(19) United States
(12) Patent Application Publication
(10) Pub. No.: US 2025/0137729 A1
(43) Pub. Date: May 1, 2025

(54) HEAT EXCHANGER AND METHOD OF MANUFACTURING A HEAT EXCHANGER

(71) Applicant: Hanon Systems, Daejeon (KR)

(72) Inventors: Peter Friesen, Niederzier (DE); Felix Girmscheid, Köln (DE); Martin Obermeier, München (DE); Matthias Herpers, Hürtgenwald (DE); Thoren Nölting, Köln (DE)

(21) Appl. No.: 18/715,797

(22) PCT Filed: May 31, 2023
(86) PCT No.: PCT/KR2023/007408

§ 371 Date: Jun. 3, 2024

(30) Foreign Application Priority Data
Jun. 10, 2022 (DE) 10 2022 205 905.0
Feb. 22, 2023 (DE) 10 2023 201 575.7

(51) Int. Cl. F28D 9/00; B23K 1/00; B23K 101/14; B23P 15/26

(52) U.S. Cl. CPC F28D 9/005; B23K 1/0012; B23P 15/26; F28D 9/0056; B23K 2101/14

(57) ABSTRACT

In a heat exchanger for use with a refrigerant under a pressure of 140 bar or more, channels for the refrigerant and another fluid are formed directly two or more plates, and at least one manifold for the refrigerant is formed outside the plates, which is connected to the channels by openings.

### CROSS REFERENCE TO RELATED PATENT APPLICATIONS

This is a U.S. national phase patent application of PCT/KR2023/007408 filed May 31, 2023 which claims the benefit of and priority to German Patent Application No. 10 2023 201 575.7 filed on Feb. 22, 2023 and German Patent Application No. 10 2022 205 905.0 filed on Jun. 10, 2022, the entire contents of each of which are incorporated herein by reference.

### TECHNICAL FIELD

The invention relates to a heat exchanger and a method of manufacturing a heat exchanger.

### BACKGROUND ART

In heat exchangers, for example in the field of automotive engineering, heat is essentially transferred between two fluids. R744 is currently being researched as an alternative to the more environmentally harmful refrigerants commonly available on the market. A challenge for the design lies in the ability to withstand the comparatively high working pressures of up to 140 bar while taking into account the transferred heat output, stability, weight and service life. This has so far been solved by encapsulating a heat exchanger having comparatively expensive extruded multi-channel flat tubes by a plastic housing. The plastic housing comprises ports for the second fluid, and the refrigerant flows through the described flat tubes connected to an inlet and outlet exposed on the plastic housing.

Another design in stationary refrigeration technology is solid plate radiators made of stainless steel, with comparatively high wall thicknesses. The areas of a plate radiator most affected by the high pressure are the distribution tanks, which distribute the refrigerant to the individual refrigerant paths or plates. In the usual design of plate radiators, a single large tank is formed into the plates. These areas define the plate thickness necessary to make the heat exchanger pressure stable.

### SUMMARY

Against this background, the object underlying the invention is that of improving such a heat exchanger for use with a refrigerant under an elevated pressure in terms of installation space, complexity, material usage and/or cost.

This object is achieved on the one hand by the heat exchanger shown and described herein, which is referred to below as a radiator without limiting the invention thereto, and which in particular can also be used as a chiller.

Accordingly, this is particularly suitable for use with a refrigerant under a pressure of 140 bar or more and comprises channels for the refrigerant and another fluid formed directly between plates, thus forming plate layers. By forming multiple channels corresponding to numerous small tanks within the plates, instead of one large tank, a very high pressure resistance is achieved with significantly reduced plate thicknesses. To distribute the refrigerant to several channels not connected in the plate, at least one manifold for the refrigerant, formed outside the plates, is further provided. It may be formed as a block, but also in any other form, although it will often be referred to as a block below, and may be manufactured as described below. Such a plate radiator can be formed, for example, by soldering suitably shaped aluminum plates together and can be made sufficiently pressure-tight. Thus, the heat exchanger can withstand a working pressure of 140 bar or a burst pressure of 260 bar or more. This is supported by the fact that the channels for the refrigerant are formed comparatively small and are present in plural for this purpose.

The possibility of forming the channels for the refrigerant and the second fluid, for example water, next to one other in such a plate radiator allows for an efficient heat transfer. At the same time, while maintaining pressure tightness, the distribution of the refrigerant to several channels, in order to make the heat transfer efficient, can be ensured by the described block. The block essentially comprises a central, in particular a single inlet and/or outlet, branched, for example via a central groove, to a plurality of openings in fluid communication with the plurality of channels in the plate radiator. At the same time, the pressure-tight connection between the respective block and an outermost plate can be made with comparatively little effort. This eliminates the need for a plastic housing or fins, which were previously necessary for efficient heat transfer. In addition, large-area portions for the distribution of the refrigerant can be avoided in the plate radiator, for which portions pressure tightness is difficult to ensure. The plates may be stamped and/or deep drawn in an efficient manner, and the block may be machined. The connection between the plates, as well as that of the outermost plate to the respective block, can be made by soldering.

Preferred further embodiments are described herein.

The invention unfolds its particular advantages with regard to reliably ensuring pressure tightness if at least one channel, preferably all channels, for the refrigerant are unbranched. In other words, no refrigerant streams are divided into two or more streams or have to be combined from two or more streams. Rather, such distribution and/or collection occurs in the block described.

For the reliable connection of two adjacent plates, in particular by means of soldering, it is advantageous if at least one intermediate plate, for example of solderable material, is arranged between pairs of plates defining channels. Furthermore, such a plate may be provided on at least one outer side of the radiator.

To ensure the distribution in particular of the refrigerant between several plates of a stack, at least one plate and/or intermediate plate comprises several openings corresponding to the channels for the refrigerant.

In order to make efficient use of the available installation space, it is preferred that the several openings are offset from one another. In other words, they are not located on one line but on two or more lines, preferably parallel to one other.

For the dimensioning of such an opening, a diameter of 2.5 to 3.5 mm, in particular approximately 3 mm, has proved advantageous.

With regard to the dimensioning of the channels, good results are expected for a depth of 0.6 to 1.0 mm, preferably approximately 0.7 mm.

Furthermore, the installation space can be kept comparatively small and efficient heat transfer can nevertheless be ensured if at least one channel extends at least simply U-shaped. In particular, several U-shaped sections can be combined to form an overall meander-shaped channel. For the distance of the two legs of the U from one other, in such a U-shaped section and in particular with regard to channels for the second fluid extending there, a value of 0.5 to 3 mm has proven to be advantageous. Furthermore, for the distance of any fluid channel, in particular for the second fluid, from the edge of the plate, a value of at least 3 mm, preferably up to 4.7 mm, is preferred.

The efficient heat transfer is further promoted by the preferred measure according to which at least one refrigerant channel and one fluid channel for the second fluid extend parallel at least in sections.

This also applies to the further preferred measure, according to which the said channels can be flowed through in countercurrent. However, they can also be provided in such a way that they are flowed through in direct current.

For the distribution of the refrigerant in the manifold to the channels, a design with at least one groove and/or chamber in the manifold is currently preferred. In the case of a chamber, several openings directed towards the plates may be provided, in particular in a number coinciding with the openings in the outermost plate of the radiator.

In the case of a groove, the uniform distribution of the refrigerant can advantageously be improved by the groove being funnel-shaped and thus widening towards the plates.

Furthermore, a baffle plate may be provided in the groove of the manifold for uniform distribution of the refrigerant.

Likewise for the equalization of the distribution of the refrigerant, the manifold can comprise a reduced diameter section in the area of its inlet, creating a kind of nozzle. In other words, between an inlet of the manifold and an outlet of the manifold towards the plates of the radiator, there is a section with a smaller diameter compared to the inlet and outlet.

In order to absorb the comparatively high pressure load, one or more webs or supports as stiffeners, for example in the form of columns, pins or trunnions, are preferred for the manifold, in particular in a groove formed therein towards the plates.

The above-mentioned object is further achieved by a method for manufacturing a radiator, in which at least one plate is stamped and/or deep-drawn and connected, preferably soldered, to a second plate, a plurality of openings are formed in at least one plate, and at least one manifold for distributing a refrigerant to the plurality of openings is machined as a block or formed from sheet metal and welded or soldered, for example. It should also be mentioned that all the features mentioned above with respect to the radiator concerning the manufacture thereof are applicable to the method according to the invention and vice versa. In other words, all the subject features mentioned with respect to the method are also applicable to the radiator according to the invention, and the foregoing also applies to all the features mentioned below.

### DESCRIPTION OF DRAWINGS

The invention is explained in more detail below with reference to an exemplary embodiment. The Figures show in:

FIG. 1 an exploded view of the radiator according to the invention,

FIG. 2 a top view of a plate of the radiator according to the invention,

FIG. 3 a bottom view of the block of the radiator according to the invention,

FIG. 4 a sectional view of the radiator according to the invention along line A-A in FIG. 2,

FIG. 5 a detail thereof, and

FIGS. 6-12 further embodiments of the manifold of the radiator according to the invention designed as a block.

### DESCRIPTION OF AN EMBODIMENT

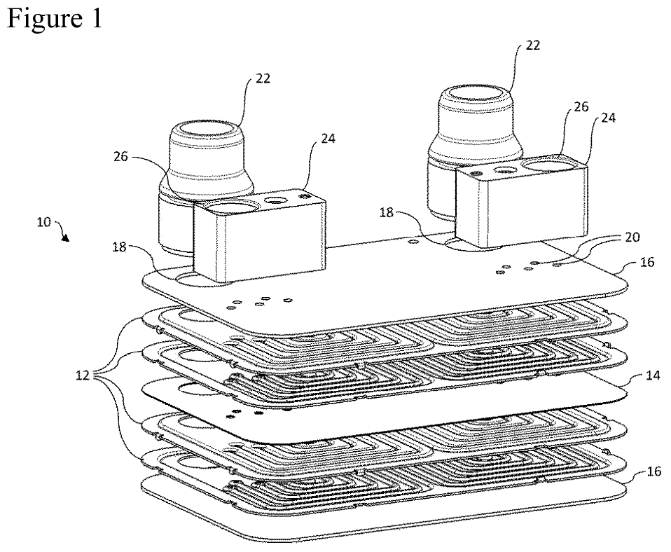

As can be seen in FIG. 1, the radiator 10 according to the invention is composed of several plates 12, which have contours for forming channels, intermediate plates 14 and two outer plates 16. In the embodiment shown, the lowest plate 16 in the figure does not have any openings, but together with the contours in the second plate 12 forms fluid channels from below.

In contrast, the uppermost plate in FIG. 1 comprises two comparatively large openings 18 for the second fluid, for example water. Furthermore, several, in the example shown two times five, comparatively small openings 20 are provided for the refrigerant. All of the openings 18, 20 are formed in all of the other plates 12, 14, 16 in the embodiment shown, except for the lowermost one, in order to distribute both the refrigerant and the second fluid into all of the spaces between the plates. However, this can also be designed differently. For example, such a plate radiator may be configured such that the fluid is distributed into only some of the plate interspaces, then diverted by suitable means, and from there directed into further plate interspaces.

An inlet or outlet 22, essentially in the form of a pipe section, is provided in each case for the second fluid. In contrast, the inlet and outlet for the refrigerant are each formed in a block 24. The largest discernible opening 26 here forms the central inlet or outlet, and the refrigerant supplied there is distributed to the individual openings 20, as described in more detail below. The intermediate plates 14 are preferably formed here in such a way that they ensure that the plates 12, 14 can be soldered together. In the example shown, all plates 12, 14, 16 are substantially congruent, rectangular in plan view and formed with rounded corners. The two blocks 24 are essentially cuboids with rounded or chamfered edges perpendicular to the plate planes.

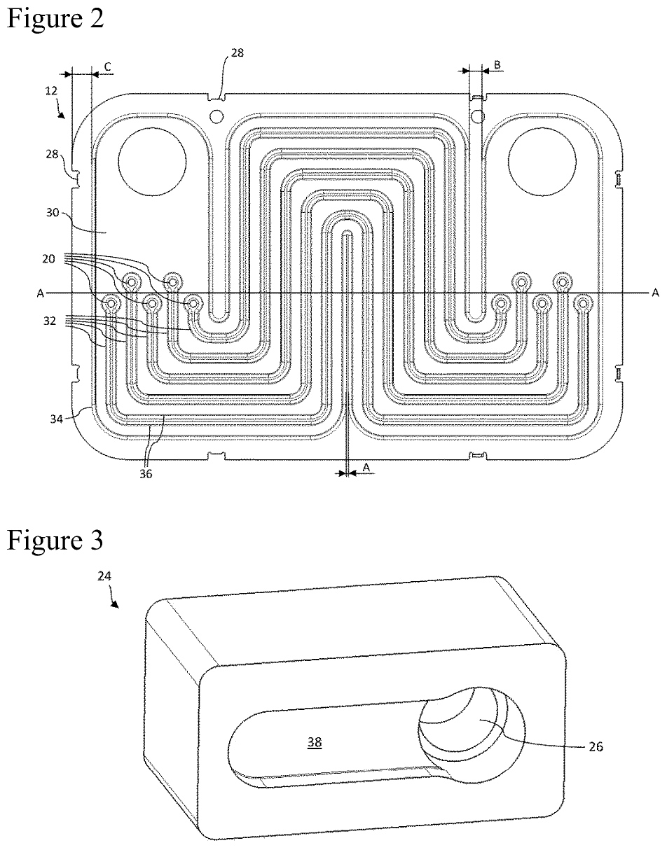

FIG. 2 shows a plate 12 in a plan view. Here, notches 28 are provided at some points along the circumference to ensure the alignment of the pairs of plates 12 with respect to each other. Furthermore, it can be seen that the second fluid flowing in through the opening 18 can initially distribute itself in an area 30 corresponding to approximately half the width of the plate (from top to bottom in FIG. 2) before fluid channels for the second fluid are defined between a plurality of parallel channels 32 for the refrigerant and between the respective outermost channel 32 and an outer boundary 34 for the channels of the second fluid and the area 30.

As can be seen in FIG. 2, all fluid channels 32 extend essentially parallel to one other and in the case shown are triple U-shaped, with the central U in the figure upside down. The transitions between the respective legs and the bottom of the U are rounded to advantageously keep the flow resistance low while making good use of the available installation space. The latter is further supported by the fact that the two times five openings 20 for the refrigerant in the case shown do not lie on one line, but are offset. In the case shown, three openings 20 lie on a first line, and the respective openings 20 lying in between lie on a second line substantially parallel to the first line. In this way, the ribs or elevations required for sealing (compare FIG. 5) can be formed in the vicinity of the openings 20, making good use of the available installation space. By means of the described ribs around the respective opening 20, which in the case shown are essentially circular, as well as by means of two parallel ribs or elevations 36 for delimiting the respective fluid channel for the refrigerant, the necessary pressure tightness can be ensured in an advantageous manner. At the same time, the aforementioned contours can be produced with reasonable effort.

The distance A in the area of the middle U in the area of the outermost water channel can be about 0.5 mm, and the distance B in the area of the two outer U about 3 mm. The outer boundary of the area 30 for the second fluid and from the outermost channel for this can be spaced from the plate edge about C=4.65 mm, and in the area of the notches still about 3.0 mm.

The block 24 shown in FIG. 3, including its opening 26 for the supply and discharge of the refrigerant, can be efficiently formed by machining, for example drilling or milling. The groove 38 adjoining the bottom side shown can be formed just as efficiently, for example by milling, and enables distribution to the openings 20 in the outermost plate of the radiator, which can be seen in FIGS. 1 and 2. In FIG. 3, it can be seen in a complementary manner that the edges of the block 24 which extend perpendicular to the plane of the plate are rounded, while the other edges are left comparatively sharp-edged. This promotes a pressure-tight connection with the outermost plate 16 of the radiator 10.

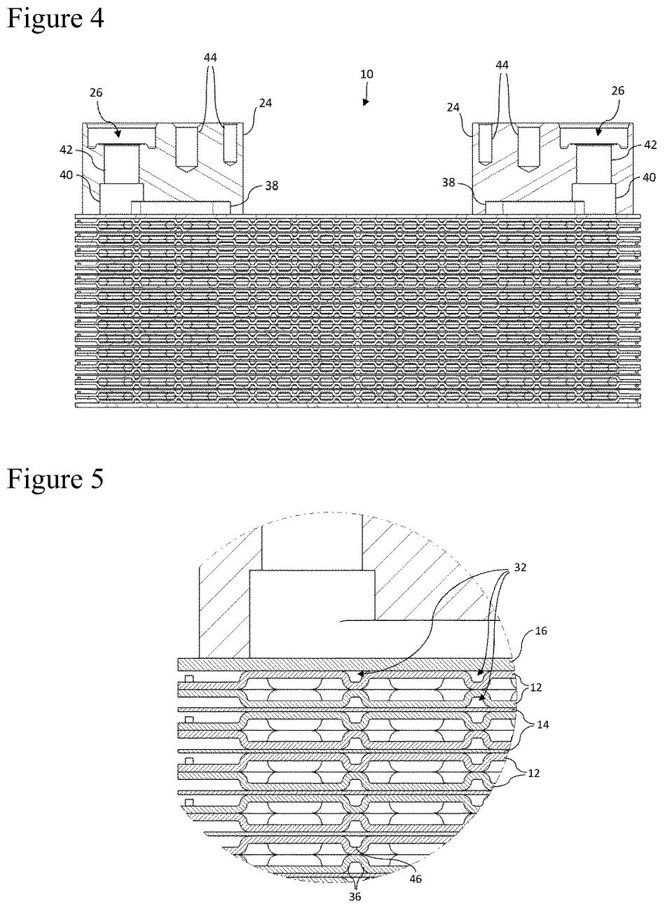

In FIG. 4, the respective block 24 with the groove 38 and the opening 26 can again be seen in the sectional view. The latter comprises a region 40 of comparatively large diameter towards the groove 38, and in a central region 42 of smaller diameter. These are of approximately equal length along the direction of flow. Towards the outside, a region approximately half as long in the case shown can be seen with a diameter larger than the region 40 of the larger diameter, which is configured for the connection of a supply and discharge line. The bottom of the groove 38 in this case is substantially parallel to the plane of the plate. As can further be seen, the groove is narrower than the diameter of the opening 26, but only by about 20% or less. Further, the groove has a depth of approximately 2 to 3 mm, and said area 40 is about twice the length of the depth of the groove.

In the case shown, the block comprises two further openings 44 for the alignment and screw connection of the counterpart for connection to the refrigerant circuit. Furthermore, FIG. 4 shows an embodiment which comprises more plates 12 than the exemplary embodiment of FIG. 1.

The detailed illustration in FIG. 5 also shows that channels 32 for the refrigerant on the one hand and the second fluid, for example water, on the other hand are directly adjacent to one other, so that efficient heat transfer is possible. Channels for the second fluid are formed here by opposing contours on two plates, while channels for the refrigerant are formed by recesses (compare the uppermost, third, etc. plate 12 in FIG. 5) or, according to the orientation shown in FIG. 5, elevations (compare the second, fourth, etc. plate 12 from above) and are separated from one another by intermediate plates 14. It can further be seen from the figure that all channels, both for the refrigerant and the second fluid, are formed integrally in one plate, substantially by a suitable corrugated shape. When the uppermost plate 12 is viewed, the elevations adjacent to the respective channel 32 on its underside form the channel for the second fluid. The “bottoms” of the above corrugations are parallel to the plane of the plate (horizontal in FIG. 5), and the channels for the second fluid are much wider, for example 7-10 times as wide as the channels 32 for the refrigerant.

As mentioned above, the channels for the refrigerant preferably have a depth of about 0.7 mm, and the channels for the second fluid accordingly have a depth of about twice this value. The bottom 46 of a refrigerant channel, which is substantially parallel to the plane of the plate, may be about 0.5 mm wide, and the rounding of this bottom to the areas adjacent thereto may be provided with a radius of approximately 0.2 mm, as may the rounding in the vicinity of the bottom of a channel for the second fluid.

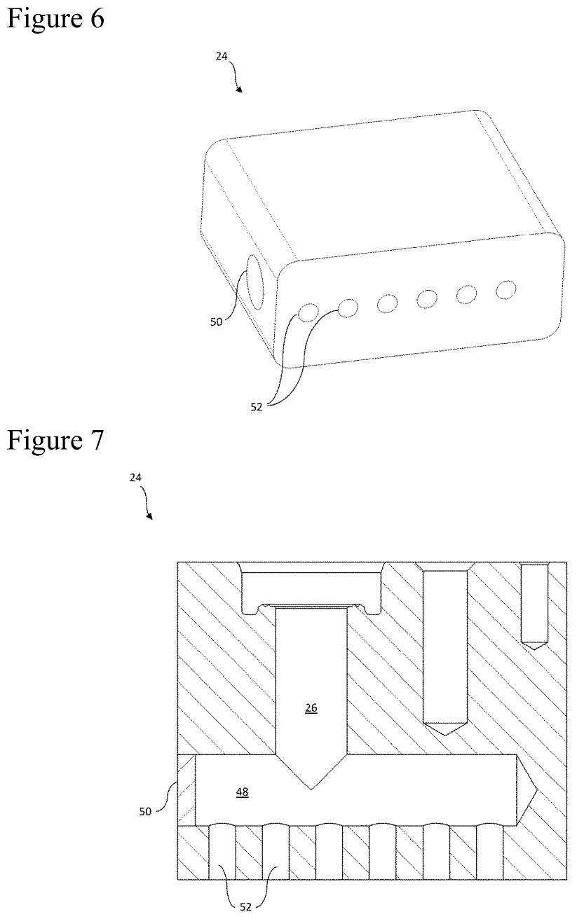

FIGS. 6 and 7 show another embodiment of the manifold in the form of a block 24. As can be seen from a comparison with FIG. 4, the difference is that a chamber 48 corresponding to the groove 38 of FIGS. 3 and 4 is formed inside the block and connected to the opening 26. The chamber 48 may be formed by drilling, for example, and may be closed by some type of cover 50. Connected to the chamber 48 in the case shown are a plurality of comparatively small openings 52 corresponding to the openings 20 in the uppermost panel of the radiator. In accordance with FIGS. 6 and 7, the openings 52 may be arranged on a line, so that the corresponding openings in the top plate of the radiator would also be arranged on a line. However, in accordance with the embodiment shown in FIGS. 1 and 2, the openings 52 may also be arranged in an offset manner in the block 24.

The chamber 48 may be configured as an elongated hole, as shown, but it may also have any other shape, such as round, rectangular, or oval, or any other suitable shape. This applies equally to the groove 38 shown in FIGS. 3 and 4.

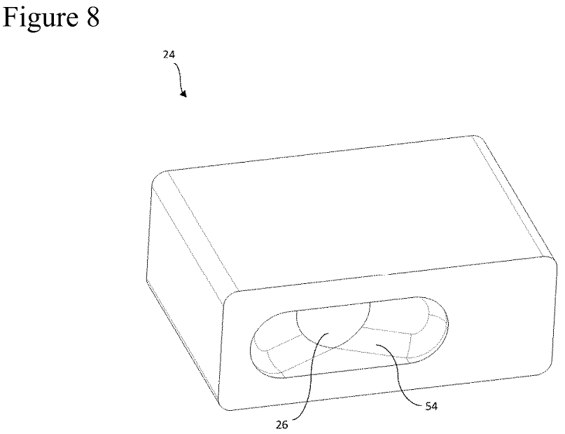

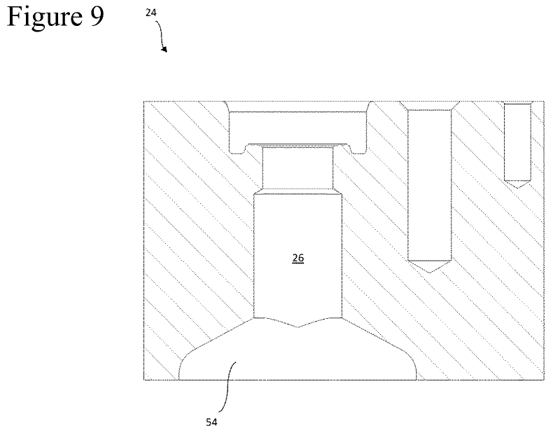

As shown in FIG. 8, the groove may also be funnel-shaped. Furthermore, particularly in this case and in the embodiments shown in FIGS. 3 and 4, a baffle plate (not shown) may be provided in the area of the funnel 54 or groove 38 for uniform distribution of the refrigerant to the openings 20 in the outermost plate of the radiator. In FIG. 9, an embodiment with funnel 54 is shown, in which the diameter of the opening 26 increases in the direction of the funnel substantially as in the embodiment of FIGS. 3 and 4.

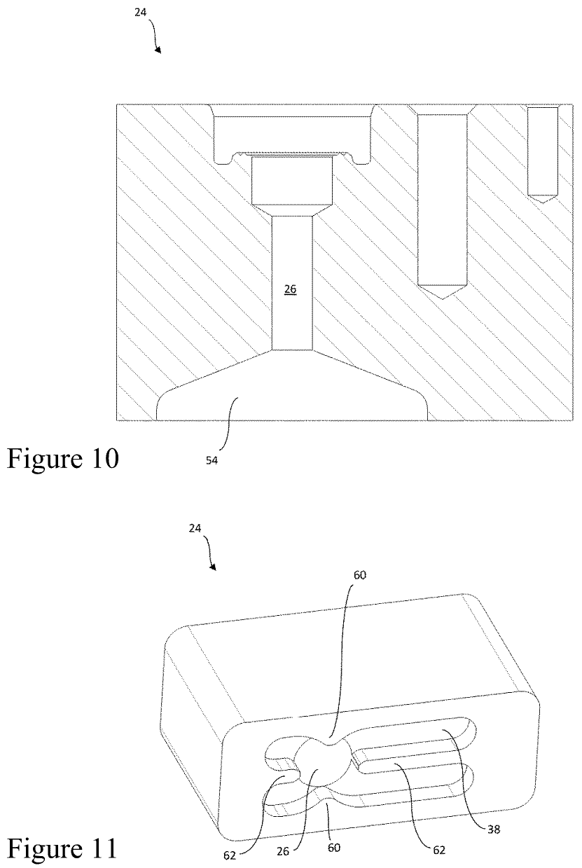

In accordance with FIG. 10, however, at least a portion of opening 26 may have a reduced diameter so as to create a nozzle that promotes even distribution of refrigerant to the openings in the outermost plate of the radiator.

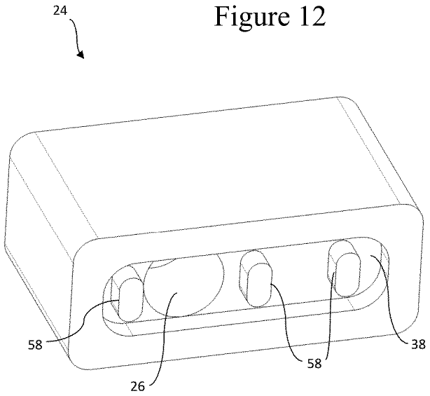

As shown in the further figures, the resulting increased pressure load can be absorbed by webs, as shown in FIG. 11 and/or supports 58, as shown in FIG. 12. These measures are shown as examples for the embodiment of FIGS. 3 and 4, but they are also applicable to the embodiment of FIGS. 8-10. In the embodiment of FIG. 11, two comparatively short webs or ribs 60 are formed around the opening 26 in the direction of the shorter side length of the lower surface of the block 24, approximately centrally of the opening 26. Similarly, two longer ridges 62 are formed adjacent the opening 26 in the direction of the longer side length.

According to FIG. 12, a plurality of supports 58 in the form of columns, pins or studs may be formed in the groove 38, for example one in the comparatively short portion of the groove 38 in the figure to the left of the opening 26, and two or more in the comparatively long portion to the right thereof. The supports 58 may be oval in cross-section, as shown, with straight longitudinal sides, circular, or other shape, and may widen toward the bottom of the groove.

The webs shown in FIG. 11 may be comparatively thin and rounded at the end in the case of an elongated design, as in the case of webs 62. Short webs, as in the case of webs 60, can have an elongated wave shape in cross-section.

1-18. (canceled)

19. A heat exchanger, in which channels for a refrigerant and a second fluid are formed directly between two or more plates, and at least one manifold for the refrigerant is formed outside the plates, which is connected to the channels by openings.

20. The heat exchanger according to claim 19, wherein at least one of the channels for the refrigerant is formed without branches.

21. The heat exchanger according to claim 19, wherein at least one solderable intermediate plate is provided between pairs of the plates defining the channels and/or on at least one outer side of the heat exchanger.

22. The heat exchanger according to claim 21, wherein at least one of the plates or the intermediate plate further comprises a plurality of the openings corresponding to the channels for the refrigerant.

23. The heat exchanger according to claim 22, wherein the plurality of the openings is arranged offset from one other.

24. The heat exchanger according to claim 19, wherein at least one of the openings has a diameter of 2.5 to 3.5 mm.

25. The heat exchanger according to claim 19, wherein at least one of the channels for the refrigerant has a depth of 0.6 to 1.0 mm.

26. The heat exchanger according to claim 19, wherein at least one of the channels for the refrigerant or the second fluid extends at least simply U-shaped.

27. The heat exchanger according to claim 19, wherein at least one of the channels for the refrigerant or the second fluid extend parallel to one another at least in sections.

28. The heat exchanger according to claim 19, wherein at least one of the channels for the refrigerant and the second fluid can be flowed through in countercurrent.

29. The heat exchanger according to claim 19, wherein the manifold further comprises at least one groove and/or chamber for distributing the refrigerant to the channels.

30. The heat exchanger according to claim 29, wherein the groove is funnel-shaped.

31. The heat exchanger according to claim 19, wherein the manifold further comprises at least one baffle plate.

32. The heat exchanger according to claim 19, wherein the manifold further comprises a reduced diameter section to form a nozzle.

33. The heat exchanger according to claim 19, wherein the manifold further comprises at least one web directed towards the plates and/or at least one support.

34. The heat exchanger according to claim 19, wherein the heat exchanger is suitable for use with the refrigerant under a pressure of 140 bar or more.

35. The heat exchanger according to claim 19, wherein the heat exchanger is a chiller or a radiator.

36. A method of manufacturing a heat exchanger, in which at least one first plate is stamped and/or deep-drawn and connected to a second plate, openings are formed in the at least one plate, and at least one manifold connected thereto for distributing a refrigerant is machined as a block or is formed from sheet metal.

37. The method according to claim 36, wherein the at least one first plate is soldered to the second plate.
